(19) United States
(12) Patent Application Publication
(10) Pub. No.: US 2025/0391294 A1
(43) Pub. Date: Dec. 25, 2025

(54) ELECTRONIC DEVICE

(71) Applicant: Innolux Corporation, Miaoli County (TW)

(72) Inventor: Kazuyuki Hashimoto, Miaoli County (TW)

(73) Assignee: Innolux Corporation, Miaoli County (TW)

(21) Appl. No.: 19/052,303

(22) Filed: Feb. 13, 2025

Related U.S. Application Data
(60) Provisional application No. 63/661,897, filed on Jun. 20, 2024.

(51) Int. Cl. G09G 3/00

(52) U.S. Cl. CPC G09G 3/001; G09G 2300/0852; G09G 2310/0208; G09G 2310/08

(57) ABSTRACT

An electronic device includes a plurality of electronic units. Each electronic unit includes a pixel circuit and a plurality of tunable circuits. The plurality of tunable circuits is coupled to the pixel circuit. and includes at least one scan transistor, a plurality of de-multiplexer transistors, a plurality of bias transistors, at least one bias-enable transistor and a plurality of storage capacitors. The plurality of de-multiplexer transistors is coupled to the at least one scan transistor. The plurality of bias transistors is coupled to the plurality of de-multiplexer transistors. The at least one bias-enable transistor is coupled to the plurality of bias transistors. The plurality of storage capacitors is coupled to a data line through the at least one scan transistor and the plurality of de-multiplexer transistors, and is coupled to at least one bias voltage line through the plurality of bias transistors and the at least one bias-enable transistor.

### CROSS-REFERENCE TO RELATED APPLICATION

This application claims the priority benefit of U.S. provisional application Ser. No. 63/661,897, filed on Jun. 20, 2024. The entirety of the above-mentioned patent application is hereby incorporated by reference herein and made a part of this specification.

### BACKGROUND

### Technical Field

The disclosure relates a device; particularly, the disclosure relates to an electronic device.

### Description of Related Art

For a conventional electronic device having a plurality of tunable circuits, when the plurality of tunable circuits is formed on a non-rectangular substrate, it is easy to make wiring and/or transistor layout difficulties, and the tunable circuit layout space in some substrate areas to become crowded and a driving of the plurality of tunable circuits to become inefficient when the plurality of tunable circuits has different tunable characteristics.

### SUMMARY

The electronic device of the disclosure includes a plurality of electronic units. Each of the plurality of electronic units includes a pixel circuit and a plurality of tunable circuits. The plurality of tunable circuits is coupled to the pixel circuit. The pixel circuit includes at least one scan transistor, a plurality of de-multiplexer transistors, a plurality of bias transistors, at least one bias-enable transistor and a plurality of storage capacitors. The plurality of de-multiplexer transistors is coupled to the at least one scan transistor. The plurality of bias transistors is coupled to the plurality of de-multiplexer transistors. The at least one bias-enable transistor is coupled to the plurality of bias transistors. The plurality of storage capacitors is coupled to a data line through the at least one scan transistor and the plurality of de-multiplexer transistors, and the plurality of storage capacitors is also coupled to at least one bias voltage line through the plurality of bias transistors and the at least one bias-enable transistor.

Base on the above, according to the electronic device of the disclosure, a number of scan lines of the electronic device may be effectively reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of the disclosure.

FIG. 2 is a schematic diagram of an electronic unit according to an embodiment of the disclosure.

FIG. 3 is a timing diagram of relevant signals according to the embodiment of the FIG. 2.

FIG. 4A and FIG. 4B are a timing diagram of relevant signals according to the embodiment of the FIG. 2.

FIG. 5 is a schematic diagram of a de-multiplexer circuit according to another embodiment of the disclosure.

FIG. 6 is a schematic diagram of a de-multiplexer circuit according to another embodiment of the disclosure.

FIG. 7 is a schematic diagram of a bias circuit according to another embodiment of the disclosure.

FIG. 8 is a schematic diagram of a bias circuit according to another embodiment of the disclosure.

FIG. 9 is a schematic diagram of a bias circuit according to another embodiment of the disclosure.

FIG. 10 is a schematic diagram of an electronic device according to another embodiment of the disclosure.

FIG. 11 is a schematic diagram of a driving circuit according to an embodiment of the disclosure.

FIG. 12 is a schematic diagram of a driving circuit according to another embodiment of the disclosure.

FIG. 13 is a schematic diagram of a driving circuit according to another embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

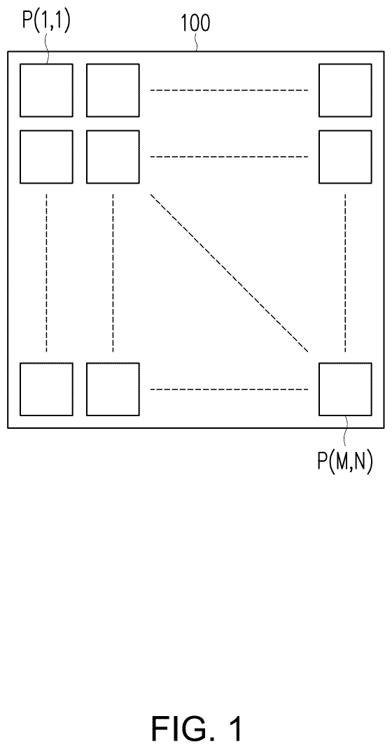

FIG. 1 is a schematic diagram of an electronic device according to an embodiment of the disclosure. Referring to FIG. 1, the electronic device 100 includes a plurality of tunable circuits P(1,1) to P(M,N), where M and N are positive integers. In the embodiment of the disclosure, the tunable circuits P(1,1) to P(M,N) may be disposed on a panel substrate, and the panel substrate may be circular, rectangular or any shape etc. The tunable circuits P(1,1) to P(M,N) may be arranged in an array or non-array manner, and are not limited to those shown in the FIG. 1. In one embodiment of the disclosure, the electronic device 100 may be a beam-steerable bidirectional antenna device, and the tunable circuits P(1,1) to P(M,N) may form a plurality of transmitter circuits and a plurality of receiver circuits of the beam-steerable bidirectional antenna device.

In the embodiment of the disclosure, the electronic device 100 may further include a plurality of data lines and a plurality of scan lines for driving the tunable circuits P(1,1) to P(M,N). The electronic device 100 may further include a plurality of electronic units (not shown in FIG. 1), and each of the electronic units may include multiple tunable circuits, such as two tunable circuits. Moreover, the each of the electronic units may further include one pixel circuit for an interlaced scanning or a selective scanning of multiple tunable circuits in a multiplexing manner.

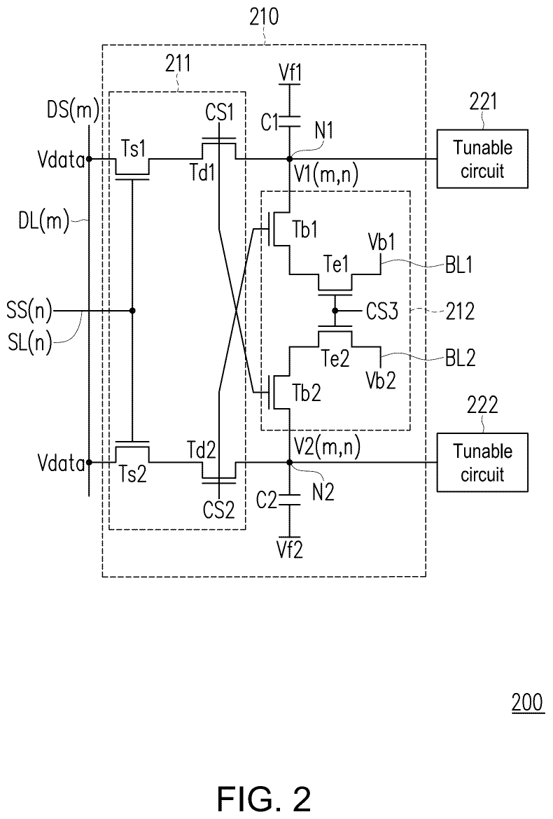

FIG. 2 is a schematic diagram of an electronic unit according to an embodiment of the disclosure. The following embodiment assumes that the electronic device 100 of FIG. 1 may have M data lines and N/2 scan lines for driving the tunable circuits P(1,1) to P(M,N). Referring to FIG. 2, each of the electronic units of the above embodiment of FIG. 1 may be implemented as the electronic unit 200 of FIG. 2, and each two adjacent tunable circuits may be implemented as two tunable circuits 221 and 222 of FIG. 2. In the embodiment of the disclosure, the electronic unit 200 includes a pixel circuit 210, and the two tunable circuits 221 and 222. The pixel circuit 210 is coupled to the tunable circuits 221 and 222. The pixel circuit 210 includes two scan transistors Ts1, Ts2, two de-multiplexer transistors Td1, Td2, two bias transistors Tb1, Tb2, two bias-enable transistors Te1, Te2 and two storage capacitors C1, C2. In the embodiment of the disclosure, the scan transistors Ts1, Ts2, the de-multiplexer transistors Td1, Td2, the two bias transistors Tb1, Tb2, and the bias-enable transistors Te1, Te2 are N-type transistors, but the disclosure is not limited thereto.

In the embodiment of the disclosure, the tunable circuits 221 and 222 may have different tunable characteristics, such as different resonant frequency tunable ranges. In the embodiment of the disclosure, each of the tunable circuits 221 and 222 includes a tunable component. In one embodiment of the disclosure, the tunable component may be a voltage-controlled and capacitance tunable component, such as a varactor diode. Moreover, the tunable circuit 221 and 222 may form a transmitter circuit and a receiver circuit which have different resonant frequency tunable ranges in beam-steerable bidirectional antenna, operate independently in a full-duplex operation or a half-duplex operation, and include varactor diodes as the voltage-controlled capacitance tunable component to tune resonant frequency of the transmitter and the receiver circuits.

In the embodiment of the disclosure, a first terminal of the scan transistor Ts1 is coupled to a data line DL(m), where m is between 1 to M. A second terminal of the scan transistor Ts1 is coupled to a first terminal of the de-multiplexer transistor Td1. A control terminal of the scan transistor Ts1 is coupled to a scan line SL(n), where n is between 1 to N/2. A second terminal of the de-multiplexer transistor Td1 is coupled to a first terminal of the storage capacitor C1, a first terminal of the bias transistor Tb1 and the tunable circuit 221 through a circuit node N1. A control terminal of the de-multiplexer transistor Td1 receives a control signal CS1. A second terminal of the storage capacitor C1 is coupled to a constant voltage Vf1.

In the embodiment of the disclosure, a first terminal of the scan transistor Ts2 is coupled to the data line DL(m). A second terminal of the scan transistor Ts2 is coupled to a first terminal of the de-multiplexer transistor Td2. A control terminal of the scan transistor Ts2 is coupled to the scan line SL(n). A second terminal of the de-multiplexer transistor Td2 is coupled to a first terminal of the storage capacitor C2, a first terminal of the bias transistor Tb2 and the tunable circuit 222 through a circuit node N2. A control terminal of the de-multiplexer transistor Td2 receives a control signal CS2. A second terminal of the storage capacitor C2 is coupled to a constant voltage Vf2.

In the embodiment of the disclosure, the bias transistors Tb1 and Tb2 is coupled between the storage capacitors C1, C2 and the bias-enable transistors Te1, Te2, respectively. A second terminal of the bias transistor Tb1 is coupled to a first terminal of the bias-enable transistor Te1. A control terminal of the bias transistor Tb1 receives the control signal CS2. A second terminal of the bias-enable transistor Te1 is coupled to a bias voltage line BL1 to receive a constant bias voltage Vb1. A control terminal of the bias-enable transistor Te1 receives a bias-enable signal CS3. A second terminal of the bias transistor Tb2 is coupled to a first terminal of the bias-enable transistor Te2. A control terminal of the bias transistor Tb2 receives the control signal CS1. A second terminal of the bias-enable transistor Te2 is coupled to a bias voltage line BL2 to receive a constant bias voltage Vb2. A control terminal of the bias-enable transistor Te2 receives the bias-enable signal CS3.

In the embodiment of the disclosure, the control terminals of the scan transistors Ts1 and Ts2 receive same scan signal SS(n) from the scan line SL(n), so that the scan transistors Ts1 and Ts2 may be turned-on at the same time to receive same data signal DS(m) with a data voltage Vdata from the data line DL(m). In the embodiment of the disclosure, the de-multiplexer transistor Td1 and the bias transistor Tb2 receive the same control signal CS1, and the de-multiplexer transistor Td2 and the bias transistor Tb1 receive the same control signal CS2. The bias-enable transistor Te1 and the bias-enable transistor Te2 receive the same bias-enable signal CS3.

In the embodiment of the disclosure, when the bias-enable transistor Te1 and the bias-enable transistor Te2 are turned-off according to the bias-enable signal CS3, the de-multiplexer transistors Td1 and Td2 receive different control signals CS1 and CS2, so that the de-multiplexer transistors Td1 and Td2 may be alternately turned-on according to the control signals CS1 and CS2 to provide the data signal DS(m) with the corresponding data voltage Vdata to the storage capacitors C1 and C2. That is, each of the storage capacitors C1 and C2 may receive a corresponding data voltage from the data line DL(m). Thus, the pixel circuit 210 may provide a driving signal with a driving voltage V1(m,n) through the circuit node N1 to drive the tunable circuit 221 according to the storage capacitor C1, and may provide a driving signal with a driving voltage V2(m,n) through the circuit node N2 to drive the tunable circuit 222 according to the storage capacitor C2.

In the embodiment of the disclosure, when the bias-enable transistor Te1 and Te2 are turned-on according to the bias-enable signal CS3, the de-multiplexer transistors Td1 and Td2 may be selectively turned-on according to the control signals CS1 and CS2 to provide the data signal DS(m) with the corresponding data voltage Vdata to the storage capacitor C1 and C2, and the bias transistors Tb1 and Tb2 may also be selectively turned-on according to the control signals CS1 and CS2 to provide the constant bias voltage Vb1 to the storage capacitor C1 or the constant bias voltage Vb2 to the storage capacitor C2. Thus, the pixel circuit 210 may provide a driving signal with the driving voltage V1(m,n) to drive the tunable circuit 221 according to the storage capacitor C1 which is applied the corresponding data voltage Vdata or the constant bias voltage Vb1, and may provide a driving signal with the driving voltage V2(m,n) to drive the tunable circuit 222 according to the storage capacitor C2 which is applied the corresponding data voltage Vdata or the constant bias voltage Vb2.

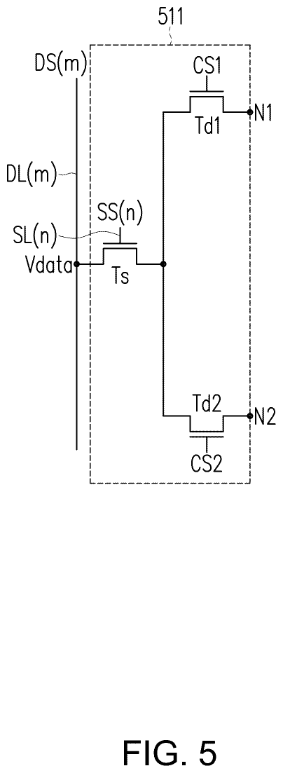

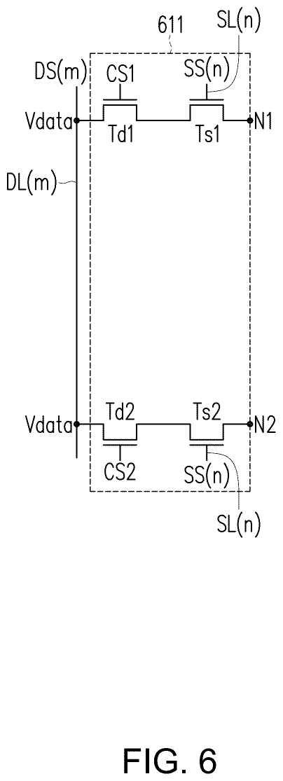

In the embodiment of the disclosure, the scan transistors Ts1, Ts2 and the de-multiplexer transistors Td1, Td2 may form a de-multiplexer circuit 211. In other embodiments of the disclosure, the de-multiplexer circuit 211 may also be replaced as any one circuit structure in the following embodiments of FIG. 5 and FIG. 6. In the embodiment of the disclosure, the bias transistors Tb1, Tb2 and the bias-enable transistors Te1, Te2 may form a bias circuit 212. In other embodiments of the disclosure, the bias circuit 212 may also be replaced as any one circuit structure in the following embodiments of FIG. 7 to FIG. 9. In addition, since the each two adjacent tunable circuit of the tunable circuits P(1,1) to P(M,N) may share the same scan line, the number of scan lines of the electronic device 100 may be effectively reduced.

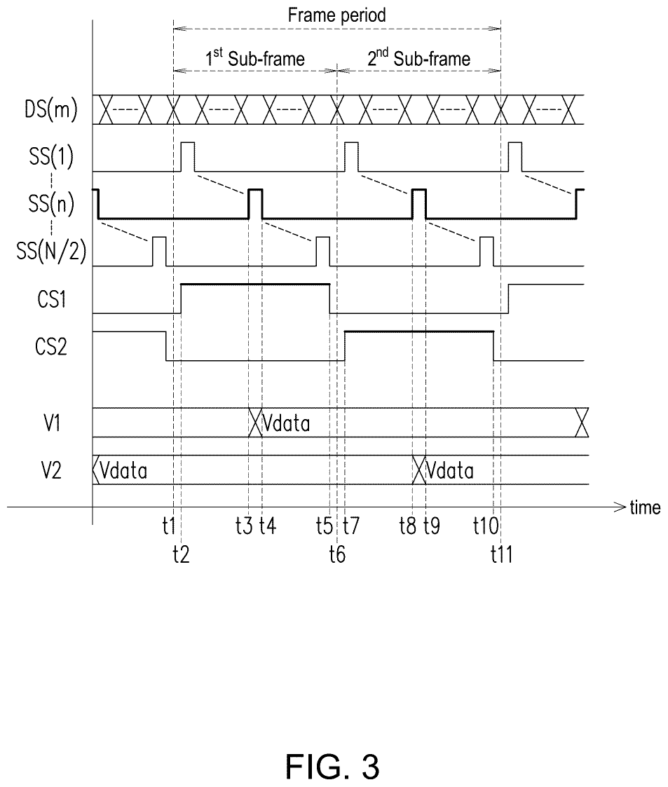

FIG. 3 is a timing diagram of relevant signals according to the embodiment of the FIG. 2. The following embodiment assumes that the electronic unit 200 may be a (m,n)-th electronic unit, and the N/2 scan lines of the electronic device may provide the scan signals SS(1) to SS(N/2) respectively. As shown in FIG. 3, the electronic unit 200 may receive the data signal DS(m), the scan signal SS(n), the control signals CS1 and CS2. In the embodiment of the disclosure, the bias-enable signal CS3 may be at a low voltage level, so that the bias-enable transistors Te1 and Te2 are turned-off. The signal waveforms of the control signals CS1 and CS2 are complementary. The electronic unit 200 may be operated in an interlaced scanning mode.

Specifically, referring to FIG. 2 and FIG. 3, during one frame period from time t1 to time t11, the pixel circuit 210 may split data writing period of the tunable circuits 221 and 222 into a first sub-frame period from time t1 to time t6 and a second sub-frame period from time t6 to time t11. Specifically, during a period from time t2 to time t5, the control signal CS1 is changed from a low voltage level to a high voltage level, and the control signal CS2 is maintained at the low voltage level. Thus, during the period from time t2 to time t5, the de-multiplexer transistor Td1 is turned-on, and the de-multiplexer transistor Td2 is turned-off. During a period from time t3 to time t4, the scan signal SS(n) is changed from the low voltage level to the high voltage level, so that the scan transistors Ts1 and Ts2 are turned-on. Thus, during the period from time t3 to time t4, the de-multiplexer transistor Td1 may provide the data signal DS(m) with the corresponding data voltage Vdata to the storage capacitor C1, so that the pixel circuit 210 may provide the driving signal with the driving voltage V1(m,n) to drive the tunable circuit 221 according to the storage capacitor C1. Furthermore, during the period from time t3 to time t4, the de-multiplexer transistor Td2 is turned-off, and does not provide the data signal DS(m) to the storage capacitor C2. Thus, the pixel circuit 210 may continue to provide the driving signal to the tunable circuit 222 corresponding to the driving voltage V2(m,n) stored in the storage capacitor C2.

Moreover, during a period from time t7 to time t10, the control signal CS2 is changed from the low voltage level to the high voltage level, and the control signal CS1 is maintained at the low voltage level. Thus, during the period from time t7 to time t10, the de-multiplexer transistor Td2 is turned-on, and the de-multiplexer transistor Td1 is turned-off. During a period from time t8 to time t9, the scan signal SS(n) is changed from the low voltage level to the high voltage level, so that the scan transistors Ts1 and Ts2 are turned-on. Thus, during the period from time t8 to time t9, the de-multiplexer transistor Td2 may provide the data signal DS(m) with the corresponding data voltage Vdata to the storage capacitor C2, so that the pixel circuit 210 may provide the driving signal with the driving voltage V2(m,n) to drive the tunable circuit 222 according to the storage capacitor C2. Furthermore, during the period from time t8 to time t9, the de-multiplexer transistor Td1 is turned-off, and does not provide the data signal DS(m) to the storage capacitor C1. Thus, the pixel circuit 210 may continue to provide the driving signal to the tunable circuit 221 corresponding to the driving voltage V1(m,n) stored in the storage capacitor C1.

In the embodiment of the disclosure, the turn-on periods of the de-multiplexer transistors Td1 and Td2 are non-overlapping. Therefore, the during one frame period, the pixel circuit 210 may split data writing period of the tunable circuits 221 and 222 into two sub-frame periods of one frame period to realize an efficient driving of the tunable circuits 221 and 222 with an interlaced scanning when the tunable circuits 221 and 222 operate independently. Moreover, for the transmitter circuits and the receiver circuits of the beam-steerable bidirectional antenna device, data writing period of each transmitter circuit and receiver circuit is split into two sub-frame periods by the pixel circuit 210 like the tunable circuits 221 and 222 with the interlaced scanning, which contributes a fast beam-steering by separate data writing of the transmitter circuits and the receiver circuits in each sub-frame period for the full-duplex operation of the beam-steerable bidirectional antenna device.

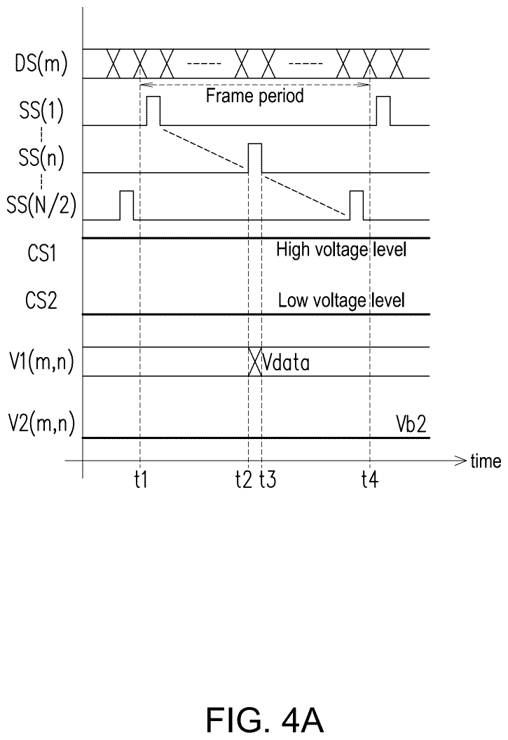

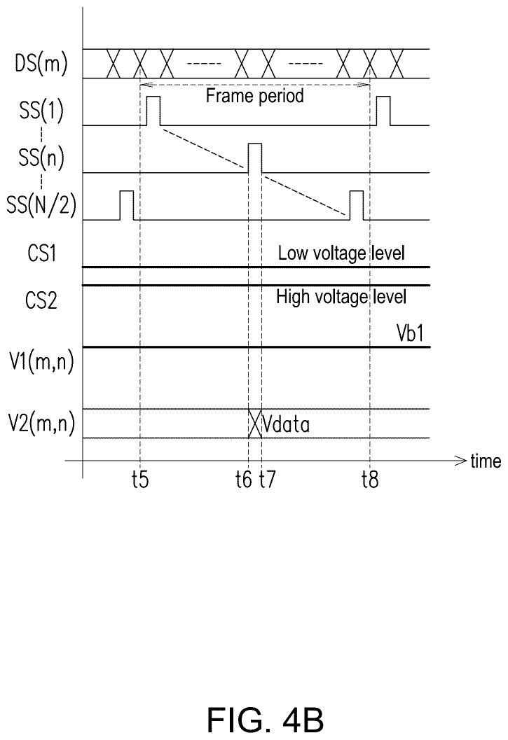

FIG. 4A and FIG. 4B are a timing diagram of relevant signals according to the embodiment of the FIG. 2. The following embodiment assumes that the electronic unit 200 may be a (m,n)-th electronic unit, and the N/2 scan lines of the electronic device may provide the scan signals SS(1) to SS(N/2) respectively. As shown in FIG. 4A, the electronic unit 200 may receive the data signal DS(m), the scan signal SS(n), the control signals CS1 and CS2. In the embodiment of the disclosure, the bias-enable signal CS3 may be at a high voltage level, so that the bias-enable transistors Te1 and Te2 are turned-on. The signal waveforms of the control signals CS1 and CS2 are complementary. The electronic unit 200 may be operated in a selective scanning mode.

Specifically, referring to FIG. 2 and FIG. 4A, during one frame period from time t1 to time t4, the pixel circuit 210 may operate a data writing operation of the tunable circuit 221. Specifically, during a period from time t1 to time t4, the control signal CS1 may be a high voltage level, and the control signal CS2 may be a low voltage level. Thus, during the period from time t1 to time t4, the de-multiplexer transistor Td1 and the bias transistor Tb2 are turned-on, and the de-multiplexer transistor Td2 and the bias transistor Tb1 are turned-off. During a period from time t2 to time t3, the scan signal SS(n) is changed from the low voltage level to the high voltage level, so that the scan transistors Ts1 and Ts2 are turned-on. Thus, during the period from time t2 to time t3, the de-multiplexer transistor Td1 may provide the data signal DS(m) with the corresponding data voltage Vdata to the first terminal of the storage capacitor C1, and the bias transistor Tb2 may provide the constant bias voltage Vb2 to the first terminal of the storage capacitor C2. The storage capacitor C1 may store the data signal DS(m) with the corresponding data voltage Vdata, and the storage capacitor C2 may store the constant bias voltage Vb2. Thus, the pixel circuit 210 may provide the driving signal with the driving voltage V1(m,n) to drive the tunable circuit 221 according to the corresponding data voltage Vdata currently stored in the storage capacitor C1, and the pixel circuit 210 may provide the driving signal with the driving voltage V2(m,n) to drive the tunable circuit 222 according to the constant bias voltage Vb2 provided by the bias transistor Tb2. Furthermore, during the period from time t2 to time t3, the de-multiplexer transistor Td2 is turned-off, and does not provide the data signal DS(m) to the first terminal of the storage capacitor C2. The bias transistor Tb1 is also turned-off, and does not provide the constant bias voltage Vb1 to the first terminal of the storage capacitor C1.

Referring to FIG. 2 and FIG. 4B, during one frame period from time t5 to time t8, the pixel circuit 210 may operate a data writing operation of the tunable circuit 222. Specifically, during a period from time t5 to time t8, the control signal CS2 may be a high voltage level, and the control signal CS1 may be a low voltage level. Thus, during the period from time t5 to time t8, the de-multiplexer transistor Td2 and the bias transistor Tb1 are turned-on, and the de-multiplexer transistor Td1 and the bias transistor Tb2 are turned-off. During a period from time t6 to time t7, the scan signal SS(n) is changed from the low voltage level to the high voltage level, so that the scan transistors Ts1 and Ts2 are turned-on. Thus, during the period from time t6 to time t7, the de-multiplexer transistor Td2 may provide the data signal DS(m) with the corresponding data voltage Vdata to the first terminal of the storage capacitor C2, and the bias transistor Tb1 may provide the constant bias voltage Vb1 to the first terminal of the storage capacitor C1. The storage capacitor C2 may store the data signal DS(m) with the corresponding data voltage Vdata, and the storage capacitor C1 may store the constant bias voltage Vb1. Thus, the pixel circuit 210 may provide the driving signal with the driving voltage V2(m,n) to drive the tunable circuit 222 according to the corresponding data voltage Vdata currently stored in the storage capacitor C2, and the pixel circuit 210 may provide the driving signal with the driving voltage V1(m,n) to drive the tunable circuit 221 according to the constant bias voltage Vb1 provided by the bias transistor Tb1. Furthermore, during the period from time t6 to time t7, the de-multiplexer transistor Td1 is turned-off, and does not provide the data signal DS(m) to the second terminal of the storage capacitor C1. The bias transistor Tb2 is also turned-off, and does not provide the constant bias voltage Vb2 to the first terminal of the storage capacitor C2.

Based on FIG. 4A and FIG. 4B, the turn-on periods of the de-multiplexer transistors Td1 and Td2 are non-overlapping, and the turn-on periods of the bias transistors Tb1 and Tb2 are also non-overlapping. The turn-on period of the de-multiplexer transistor Td1 and the turn-on period of the bias transistor Tb1 are also non-overlapping. The turn-on period of the de-multiplexer transistor Td2 and the turn-on period of the bias transistor Tb2 are also non-overlapping.

Therefore, the pixel circuit 210 may selectively drive the tunable circuit 221 or the tunable circuit 222 according to control signals CS1 and CS2 in different frame periods to realize an efficient driving of the tunable circuit 221 or the tunable circuit 222 with a selective scanning in which the corresponding data voltage Vdata may be applied to a working tunable circuit (i.e. the tunable circuit 221 or the tunable circuit 222) and the corresponding constant bias voltage may be applied to a non-working tunable circuit (i.e. the tunable circuit 222 or the tunable circuit 221).

Moreover, for the transmitter circuits and the receiver circuits of the beam-steerable bidirectional antenna device, the pixel circuit 210 may selectively apply the corresponding data voltage Vdata to the transmitter circuit or the receiver circuit as a working tunable circuit and apply the corresponding constant bias voltage to the other as a non-working tunable circuit with the selective scanning, which contributes a fast beam-steering by data writing of the transmitter circuits or the receiver circuits for the half-duplex operation of the beam-steerable bidirectional antenna device.

FIG. 5 is a schematic diagram of a de-multiplexer circuit according to another embodiment of the disclosure. Referring to FIG. 5, in the embodiment of the disclosure, the de-multiplexer circuit 211 of FIG. 2 may be replaced to the de-multiplexer circuit 511. The de-multiplexer circuit 511 includes one scan transistor Ts and two de-multiplexer transistors Td1, Td2. The scan transistor Ts is coupled between a data line DL(m) and the de-multiplexer transistors Td1, Td2. A first terminal of the scan transistor Ts is coupled to the data line DL(m). A second terminal of the scan transistor Ts is coupled to a first terminal of the de-multiplexer transistor Td1 and a first terminal of the de-multiplexer transistor Td2. The control terminal of the scan transistor Ts is coupled to a scan line SL(n). A second terminal of the de-multiplexer transistor Td1 is coupled to a circuit node N1 (same as the circuit node N1 shown in FIG. 2). A second terminal of the de-multiplexer transistor Td2 is coupled to a circuit node N2 (same as the circuit node N2 shown in FIG. 2).

In the embodiment of the disclosure, the control terminal of the scan transistor Ts receives a scan signal SS(n) (same as the scan signal SS(n) shown in FIG. 2) from the scan line SL(n). The control terminal of the de-multiplexer transistor Td1 receives a control signal CS1 (same as the control signal CS1 shown in FIG. 2). The control terminal of the de-multiplexer transistor Td2 receives a control signal CS2 (same as the control signal CS2 shown in FIG. 2). In the embodiment of the disclosure, the de-multiplexer circuit 511 may also be applied the relevant signals as shown in FIG. 3 to FIG. 4B, so as to realize same de-multiplexer operate function as descriptive in the embodiments of FIG. 3 to FIG. 4B. In addition, in the embodiment of the disclosure, the number of scan transistors of the electronic device applied the de-multiplexer circuit 511 may be effectively reduced.

FIG. 6 is a schematic diagram of a de-multiplexer circuit according to another embodiment of the disclosure. Referring to FIG. 6, in the embodiment of the disclosure, the de-multiplexer circuit 211 of FIG. 2 may be replaced to the de-multiplexer circuit 611. The de-multiplexer circuit 611 includes two scan transistors Ts1, Ts2 and two de-multiplexer transistors Td1, Td2. The de-multiplexer transistors Td1, Td2 are coupled between a data line DL(m) and the scan transistors Ts1, Ts2. A first terminal of the de-multiplexer transistors Td1 is coupled to the data line DL(m). A second terminal of the de-multiplexer transistors Td1 is coupled to a first terminal of the scan transistor Ts1. A first terminal of the de-multiplexer transistors Td2 is coupled to the data line DL(m). A second terminal of the de-multiplexer transistors Td2 is coupled to a first terminal of the scan transistor Ts2. A second terminal of the scan transistor Ts1 is coupled to a circuit node N1 (same as the circuit node N1 shown in FIG. 2). A control terminal of the scan transistor Ts1 is coupled to a scan line SL(n). A second terminal of the scan transistor Ts2 is coupled to a circuit node N2 (same as the circuit node N2 shown in FIG. 2). A control terminal of the scan transistor Ts2 is coupled to the scan line SL(n).

In the embodiment of the disclosure, the control terminal of the scan transistors Ts1, Ts2 receive same scan signal SS(n) (same as the scan signal SS(n) shown in FIG. 2) from the scan line SL(n). The control terminal of the de-multiplexer transistor Td1 receives a control signal CS1 (same as the control signal CS1 shown in FIG. 2). The control terminal of the de-multiplexer transistor Td2 receives a control signal CS2 (same as the control signal CS2 shown in FIG. 2). In the embodiment of the disclosure, the de-multiplexer circuit 611 may also be applied the relevant signals as shown in FIG. 3 to FIG. 4B, so as to realize same de-multiplexer operate function as descriptive in the embodiments of FIG. 3 to FIG. 4B.

FIG. 7 is a schematic diagram of a bias circuit according to another embodiment of the disclosure. Referring to FIG. 7, in the embodiment of the disclosure, the bias circuit 212 of FIG. 2 may be replaced to the bias circuit 712. The bias circuit 712 includes two bias transistors Tb1, Tb2 and one bias-enable transistor Te. A first terminal of the bias transistor Tb1 is coupled to a circuit node N1 (same as the circuit node N1 shown in FIG. 2). A second terminal of the bias transistor Tb1 is coupled to a first terminal of the bias-enable transistor Te and a first terminal of the bias transistor Tb2. A second terminal of the bias transistor Tb2 is coupled to a circuit node N2 (same as the circuit node N2 shown in FIG. 2). A second terminal of the bias-enable transistor Te is coupled to a bias voltage line BL. That is, the bias transistors Tb1, Tb2 is coupled between storage capacitors C1, C2 as shown in FIG. 2 and the bias-enable transistor Te, respectively.

It should be noted that, when the bias transistor Tb1 is turned-on, the bias voltage line BL may provide a constant bias voltage Vb1 (same as the constant bias voltage Vb1 shown in FIG. 2) to applied to the circuit node N1. When the bias transistor Tb2 is turned-on, the bias voltage line BL may provide a constant bias voltage Vb2 (same as the constant bias voltage Vb2 shown in FIG. 2) to applied to the circuit node N2.

In the embodiment of disclosure, a control terminal of the bias transistor Tb1 receives a control signal CS2 (same as the control signal CS2 shown in FIG. 2). A control terminal of the bias transistor Tb2 receives a control signal CS1 (same as the control signal CS1 shown in FIG. 2). A control terminal of the bias-enable transistor Te receives a bias-enable signal CS3 (same as the bias-enable signal CS3 shown in FIG. 2). In the embodiment of the disclosure, the bias circuit 712 may also be applied the relevant signals as shown in FIG. 3 to FIG. 4B, so as to realize same bias operate function as descriptive in the embodiments of FIG. 3 to FIG. 4B. In addition, in the embodiment of the disclosure, the number of bias-enable transistors and number of bias voltage lines of the electronic device applied the bias circuit 712 may be effectively reduced.

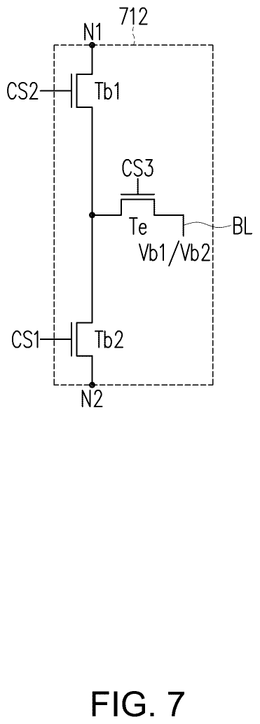

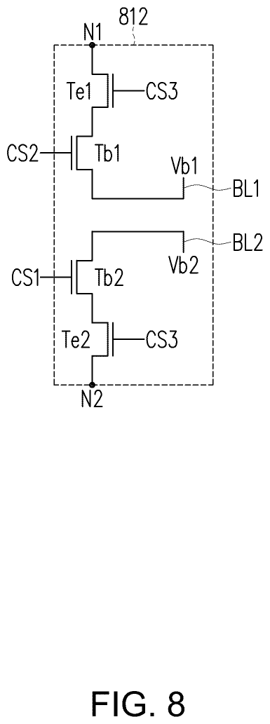

FIG. 8 is a schematic diagram of a bias circuit according to another embodiment of the disclosure. Referring to FIG. 8, in the embodiment of the disclosure, the bias circuit 212 of FIG. 2 may be replaced to the bias circuit 812. The bias circuit 812 includes two bias transistors Tb1, Tb2 and two bias-enable transistors Te1, Te2. A first terminal of the bias-enable transistor Te1 is coupled to a circuit node N1 (same as the circuit node N1 shown in FIG. 2). A second terminal of the bias-enable transistor Te1 is coupled to a first terminal of the bias transistor Tb1. A second terminal of the bias transistor Tb1 is coupled to a bias voltage line BL1 to receive a constant bias voltage Vb1 (same as the constant bias voltage Vb1 shown in FIG. 2). A first terminal of the bias transistor Tb2 is coupled to a bias voltage line BL2 to receive a constant bias voltage Vb2 (same as the constant bias voltage Vb2 shown in FIG. 2). A second terminal of the bias transistor Tb2 is coupled to a first terminal of the bias-enable transistor Te2. A second terminal of the bias-enable transistor Te2 is coupled to a circuit node N2 (same as the circuit node N2 shown in FIG. 2).

In the embodiment of disclosure, a control terminal of the bias transistor Tb1 receives a control signal CS2 (same as the control signal CS2 shown in FIG. 2). A control terminal of the bias transistor Tb2 receives a control signal CS1 (same as the control signal CS1 shown in FIG. 2). A control terminal of the bias-enable transistor Te1 and a control terminal of the bias-enable transistor Te2 respectively receives a bias-enable signal CS3 (same as the bias-enable signal CS3 shown in FIG. 2). In the embodiment of the disclosure, the bias circuit 812 may also be applied the relevant signals as shown in FIG. 3 to FIG. 4B, so as to realize same bias operate function as descriptive in the embodiments of FIG. 3 to FIG. 4B.

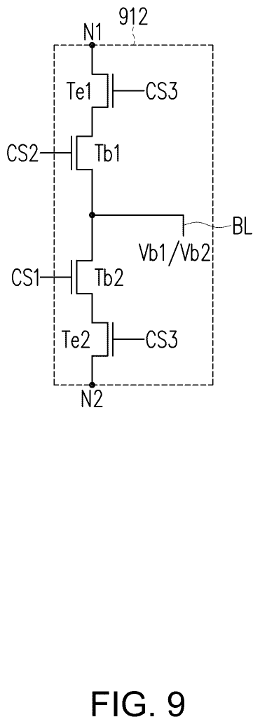

FIG. 9 is a schematic diagram of a bias circuit according to another embodiment of the disclosure. Referring to FIG. 9, in the embodiment of the disclosure, the bias circuit 212 of FIG. 2 may be replaced to the bias circuit 912. The bias circuit 912 includes two bias transistors Tb1, Tb2 and two bias-enable transistors Te1, Te2. A first terminal of the bias-enable transistor Te1 is coupled to a circuit node N1 (same as the circuit node N1 shown in FIG. 2). A second terminal of the bias-enable transistor Te1 is coupled to a first terminal of the bias transistor Tb1. A second terminal of the bias transistor Tb1 is coupled to a first terminal of the bias transistor Tb2 and a bias voltage line BL. A second terminal of the bias transistor Tb2 is coupled to a first terminal of the bias-enable transistor Te2. A second terminal of the bias-enable transistor Te2 is coupled to a circuit node N2 (same as the circuit node N2 shown in FIG. 2). The bias-enable transistor Te1 is coupled between the bias transistor Tb1 and the storage capacitor (i.e. the storage capacitor C1 as shown in FIG. 2). The bias-enable transistor Te2 is coupled between the bias transistor Tb2 and the storage capacitor (i.e. the storage capacitor C2 as shown in FIG. 2).

It should be noted that, when the bias transistor Tb1 is turned-on, the bias voltage line BL may provide a constant bias voltage Vb1 (same as the constant bias voltage Vb1 shown in FIG. 2) to applied to the circuit node N1. When the bias transistor Tb2 is turned-on, the bias voltage line BL may provide a constant bias voltage Vb2 (same as the constant bias voltage Vb2 shown in FIG. 2) to applied to the circuit node N2.

In the embodiment of disclosure, a control terminal of the bias transistor Tb1 receives a control signal CS2 (same as the control signal CS2 shown in FIG. 2). A control terminal of the bias transistor Tb2 receives a control signal CS1 (same as the control signal CS1 shown in FIG. 2). A control terminal of the bias-enable transistor Te1 and a control terminal of the bias-enable transistor Te2 respectively receives a bias-enable signal CS3 (same as the bias-enable signal CS3 shown in FIG. 2). In the embodiment of the disclosure, the bias circuit 912 may also be applied the relevant signals as shown in FIG. 3 to FIG. 4B, so as to realize same bias operate function as descriptive in the embodiments of FIG. 3 to FIG. 4B. In addition, in the embodiment of the disclosure, the number of bias voltage lines of the electronic device applied the bias circuit 912 may be effectively reduced.

FIG. 10 is a schematic diagram of an electronic device according to another embodiment of the disclosure. The following embodiment assumes that the electronic device 100 of FIG. 1 may have M data lines and N/2 scan lines for driving the tunable circuits P(1,1) to P(M,N). Referring to FIG. 10, each of the electronic units of the above embodiment of FIG. 1 may be implemented as the electronic unit 1000 of FIG. 10, and each two adjacent tunable circuits may be implemented as two tunable circuits 1021 and 1022 of FIG. 10. In the embodiment of the disclosure, the electronic unit 1000 includes a pixel circuit 1010, and the two tunable circuits 1021 and 1022. The pixel circuit 1010 is coupled to the tunable circuits 1021 and 1022. The pixel circuit 210 includes two scan transistors Ts1, Ts2, two de-multiplexer transistors Td1, Td2, two bias transistors Tb1, Tb2, two bias-enable transistors Te1, Te2, two storage capacitors C1, C2 and two driving circuits 1013, 1014.

In the embodiment of the disclosure, a first terminal of the scan transistor Ts1 is coupled to a data line DL(m), where m is between 1 to M. A second terminal of the scan transistor Ts1 is coupled to a first terminal of the de-multiplexer transistor Td1. A control terminal of the scan transistor Ts1 is coupled to a scan line SL(n), where n is between 1 to N/2. A second terminal of the de-multiplexer transistor Td1 is coupled to a first terminal of the storage capacitor C1, a first terminal of the bias transistor Tb1 and the driving circuit 1013 through a circuit node N1. The driving circuit 1013 is further coupled to the tunable circuit 1021. A control terminal of the de-multiplexer transistor Td1 receives a control signal CS1. A second terminal of the storage capacitor C1 is coupled to a constant voltage Vf1.

In the embodiment of the disclosure, a first terminal of the scan transistor Ts2 is coupled to the data line DL(m). A second terminal of the scan transistor Ts2 is coupled to a first terminal of the de-multiplexer transistor Td2. A control terminal of the scan transistor Ts2 is coupled to the scan line SL(n). A second terminal of the de-multiplexer transistor Td2 is coupled to a first terminal of the storage capacitor C2, a first terminal of the bias transistor Tb2 and the driving circuit 1014 through a circuit node N2. The driving circuit 1014 is further coupled to the tunable circuit 1022. A control terminal of the de-multiplexer transistor Td2 receives a control signal CS2. A second terminal of the storage capacitor C2 is coupled to a constant voltage Vf2.

In the embodiment of the disclosure, the bias transistors Tb1, Tb2 is coupled between the storage capacitors C1, C2 and the bias-enable transistors Te1, Te2, respectively. A second terminal of the bias transistor Tb1 is coupled to a first terminal of the bias-enable transistor Te1. A control terminal of the bias transistor Tb1 receives the control signal CS2. A second terminal of the bias-enable transistor Te1 is coupled to a bias voltage line BL1 to receive a constant bias voltage Vb1. A control terminal of the bias-enable transistor Te1 receives a bias-enable signal CS3. A second terminal of the bias transistor Tb2 is coupled to a first terminal of the bias-enable transistor Te2. A control terminal of the bias transistor Tb2 receives the control signal CS1. A second terminal of the bias-enable transistor Te2 is coupled to a bias voltage line BL2 to receive a constant bias voltage Vb2. A control terminal of the bias-enable transistor Te2 receives the bias-enable signal CS3.

In the embodiment of the disclosure, the control terminals of the scan transistors Ts1 and Ts2 receive same scan signal SS(n) from the scan line SL(n), so that the scan transistors Ts1 and Ts2 may be turned-on at the same time to receive same data signal DS(m) with a data voltage Vdata from the data line DL(m). In the embodiment of the disclosure, the de-multiplexer transistor Td1 and the bias transistor Tb2 receive the same control signal CS1, and the de-multiplexer transistor Td2 and the bias transistor Tb1 receive the same control signal CS2. The bias-enable transistor Te1 and the bias-enable transistor Te2 receive the same bias-enable signal CS3.

Different from the embodiment of FIG. 2, the pixel circuit 1010 further includes the driving circuits 1013, 1014 to enhance driving capability. In one embodiment of the disclosure, the driving circuits 1013 and 1014 may be further configured to convert multiple driving voltages into multiple driving currents to control the tunable circuits 1021 and 1022 with current instead of voltage.

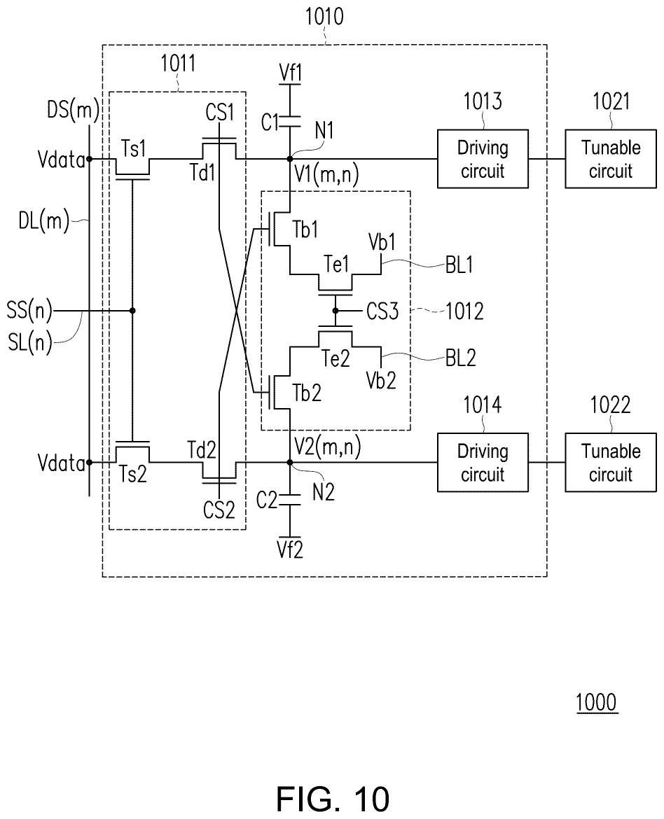

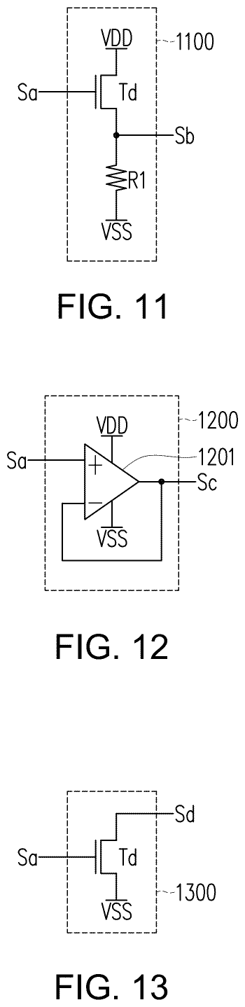

FIG. 11 is a schematic diagram of a driving circuit according to an embodiment of the disclosure. Referring to FIG. 11, the driving circuits 1013, 1014 of the above embodiment of FIG. 10 may be respectively implemented as the driving circuit 1100. In the embodiments of the disclosure, the driving circuit 1100 includes a driving transistor Td and a resistor R1. A first terminal of the driving transistor Td is coupled to a first operation voltage VDD. A second terminal of the driving transistor Td is coupled to a first terminal of the resistor R1. A control terminal of the driving transistor Td receives a driving signal Sa with a driving voltage provided by the corresponding capacitor (e.g. the storage capacitor C1 or the storage capacitor C2 in FIG. 10). A second terminal of the resistor R1 is coupled to a second operation voltage VSS. In the embodiment of the disclosure, the driving transistor Td may be a N-type transistor. The first operation voltage VDD may be higher than the second operation voltage VSS. In the embodiment of the disclosure, the driving transistor Td may be operated as a source follower amplifier to convert the driving signal Sa to a driving signal Sb with another driving voltage (i.e. enhance driving capability) for driving the corresponding tunable circuit (e.g. the tunable circuit 1021 or the tunable circuit 1022 in FIG. 10).

FIG. 12 is a schematic diagram of a driving circuit according to another embodiment of the disclosure. Referring to FIG. 12, the driving circuits 1013, 1014 of the above embodiment of FIG. 10 may be respectively implemented as the driving circuit 1200. In the embodiments of the disclosure, the driving circuit 1200 includes an operational amplifier 1201. A non-inverting input terminal of the operational amplifier 1201 may receive a driving signal Sa with a driving voltage provided by the corresponding capacitor (e.g. the storage capacitor C1 or the storage capacitor C2 in FIG. 10). An inverting input terminal of the operational amplifier 1201 is coupled to an output terminal of operational amplifier 1201. The operational amplifier 1201 is further coupled to a first operation voltage VDD and a second operation voltage VSS. In the embodiment of the disclosure, the operational amplifier 1201 is configured as a voltage amplifier, and configured to convert the driving signal Sa to a driving signal Sc with another driving voltage (i.e. enhance driving capability) for driving the corresponding tunable circuit (e.g. the tunable circuit 1021 or the tunable circuit 1022 in FIG. 10).

FIG. 13 is a schematic diagram of a driving circuit according to another embodiment of the disclosure. Referring to FIG. 13, the driving circuits 1013, 1014 of the above embodiment of FIG. 10 may be respectively implemented as the driving circuit 1300. In the embodiments of the disclosure, the driving circuit 1300 includes a driving transistor Td. A first terminal of the driving transistor Td is coupled to the corresponding tunable circuit (e.g. the tunable circuit 1021 or the tunable circuit 1022 in FIG. 10). A second terminal of the driving transistor Td is coupled to a second operation voltage VSS. A control terminal of the driving transistor Td receives a driving signal Sa with a driving voltage provided by the corresponding capacitor (e.g. the storage capacitor C1 or the storage capacitor C2 in FIG. 10). In the embodiment of the disclosure, the driving transistor Td may be a N-type transistor. The driving transistor Td may be operated as a current driver to convert the driving signal Sa to a driving signal Sd with driving current for driving the corresponding tunable circuit.

In summary, the electronic device of the disclosure may effectively drive multiple tunable circuits through the interlaced scan or selective scan. Moreover, the electronic device of the disclosure may use fewer scan lines and fewer scan transistors to effectively reduce the circuit layout area and device volume.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, comprising:
a plurality of electronic units, wherein each of the plurality of electronic units comprises:
a pixel circuit; and
a plurality of tunable circuits, coupled to the pixel circuit,
wherein the pixel circuit comprises:
at least one scan transistor;
a plurality of de-multiplexer transistors, coupled to the at least one scan transistor;
a plurality of bias transistors, coupled to the plurality of de-multiplexer transistors;
at least one bias-enable transistor, coupled to the plurality of bias transistors; and
a plurality of storage capacitors, coupled to a data line through the at least one scan transistor and the plurality of de-multiplexer transistors, and coupled to at least one bias voltage line through the plurality of bias transistors and the at least one bias-enable transistor.

2. The electronic device according to claim 1, wherein the pixel circuit comprises a plurality of scan transistors, and the plurality of scan transistors receive same scan signal.

3. The electronic device according to claim 2, wherein the plurality of de-multiplexer transistors is coupled between the data line and the plurality of scan transistors.

4. The electronic device according to claim 1, wherein the plurality of de-multiplexer transistors and the plurality of bias transistors receive a plurality of control signals.

5. The electronic device according to claim 4, wherein signal waveforms of the plurality of control signals are complementary, and turn-on periods of the plurality of de-multiplexer transistors are non-overlapping.

6. The electronic device according to claim 5, wherein turn-on periods of the plurality of bias transistors are non-overlapping.

7. The electronic device according to claim 4, wherein signal waveforms of the plurality of control signals are complementary, and turn-on periods of one of the plurality of de-multiplexer transistors and one of the plurality of bias transistors are non-overlapping.

8. The electronic device according to claim 1, wherein the pixel circuit comprises a plurality of bias-enable transistors, and the plurality of bias-enable transistors receive same bias-enable signal.

9. The electronic device according to claim 8, wherein the plurality of bias-enable transistors is coupled between the plurality of storage capacitors and the plurality of bias transistors.

10. The electronic device according to claim 1, wherein the at least one scan transistor is coupled between the data line and the plurality of de-multiplexer transistors.

11. The electronic device according to claim 10, wherein the pixel circuit comprises one scan transistor.

12. The electronic device according to claim 1, wherein the plurality of bias transistors is coupled between the plurality of storage capacitors and the at least one bias-enable transistor.

13. The electronic device according to claim 12, wherein the pixel circuit comprises one bias-enable transistor.

14. The electronic device according to claim 1, wherein each of the plurality of storage capacitors receives a data voltage from the data line or a constant bias voltage from the at least one bias voltage line.

15. The electronic device according to claim 14, wherein the pixel circuit is configured to provide a driving signal to each of the plurality of tunable circuits corresponding to the data voltage or a constant bias voltage.

16. The electronic device according to claim 1, wherein the plurality of tunable circuits has different tunable characteristics.

17. The electronic device according to claim 16, wherein the plurality of tunable circuits has different resonant frequency tunable ranges.

18. The electronic device according to claim 1, wherein each of the plurality of tunable circuits comprises a tunable component.

19. The electronic device according to claim 18, wherein the tunable component is a capacitance tunable component.

20. The electronic device according to claim 1, wherein the electronic device is a beam-steerable bidirectional antenna device.
